(19) United States
(12) Patent Application Publication
(10) Pub. No.: US 2019/0162872 A1
(43) Pub. Date: May 30, 2019

(54) System and Method of Estimating Leakage Current Distribution Along Long Conductor Extending into the Earth

(71) Applicant: GroundMetrics, Inc., San Diego, CA (US)

(72) Inventors: H. Frank MORRISON, Berkeley, CA (US); Michael WILT, Walnut Creek, CA (US); Greg NIEUWENHUIS, Powell River (CA)

(73) Assignee: GroundMetrics, Inc., San Diego, CA (US)

(21) Appl. No.: 16/323,194

(22) PCT Filed: Sep. 1, 2017
(86) PCT No.: PCT/US17/49936

§ 371 Date: Feb. 4, 2019

Related U.S. Application Data
(60) Provisional application No. 62/382,549, filed on Sep. 1, 2016.

(51) Int. Cl. G01V 3/38; G01V 3/20; E21B 47/10

(52) U.S. Cl. CPC G01V 3/38; E21B 47/10; G01V 3/20

(57) ABSTRACT

A system measures and/or estimates the distribution of current flowing in or on a Long Conductor, such as a borehole casing. This allows greater precision in data interpretation and in calculating input to geologic models.

### CROSS-REFERENCE TO RELATED APPLICATIONS

This application claims the benefit of U.S. Provisional Application No. 62/382,549, which was filed on Sep. 1, 2016 and titled “Measurement of Casing Current for Borehole to Surface Electromagnetic Surveys”. The entire content of this application is incorporated herein by reference.

### FIELD OF THE INVENTION

The subject invention is directed to a system and method for estimating a leakage current distribution along a long conductor extending into the earth and for performing an electromagnetic geophysical survey of a subsurface volume of the earth. More specifically, the present invention provides a method for obtaining an accurate measurement or estimate of the electrical current along the long conductor and, in turn, of the current leaving the long conductor.

### BACKGROUND OF THE INVENTION

Efficient development of most oilfields requires knowledge of the location and extent of oil rich zones that have not been intersected by oil wells or of the location of oil-water boundaries. This is true both for understanding how to better develop the field and in applications such as geosteering where this knowledge is key to placing a well where it can produce most effectively. It is also important to monitor oil boundaries when water, steam, CO₂ or other flood-enhanced recovery techniques are used. Electromagnetic methods of geophysics are particularly well suited for mapping these situations because there is often a high contrast in electrical resistance between the fluids present in the formation or injected during improved oil recovery or enhanced oil recovery and the oil-saturated reservoir. Improved oil recovery is often referred to as secondary recovery, and enhanced oil recovery is often referred to as tertiary recovery. Herein, the terms are interchangeable.

Because most reservoirs are confined to sedimentary formations that are relatively thin compared to their depth below the surface, it is difficult or impossible to map the resistivity variations in the zone of interest using surface-based electromagnetic techniques. It is known that the sensitivity of these models is increased dramatically if the sources of electromagnetic fields can be located in the vicinity of the region of interest.

One well demonstrated method involves injecting current in the earth between two electrodes and measuring the distortions in electric field on the surface or in adjacent drill holes caused by the resistivity variations in the subsurface region of interest. One way to increase the current injected at depth is by using the long conductor to provide an easy pathway for current to flow deeper into the subsurface. The major problem with this approach is that the current flow off the Long conductor should be approximated using a geologic model assumed to represent the formation resistivity adjacent to the long conductor. If the current leaving the Long conductor is not accurately known or accurately approximated, then subsequent modeling to find a subsurface distribution of electrical resistivity that matches the observed electric or magnetic responses will likely have greater error.

As noted above, for the efficient development of most oilfields, it is advantageous to know the location and extent of oil rich zones that have not been intersected by oil wells (the problem of bypassed oil) or the location of oil-water boundaries or other boundaries and to monitor these boundaries over time as the field is produced. It is also important to monitor oil-water boundaries and other boundaries when water flood or other enhanced recovery techniques are used. Finally, it is important to locate the boundaries of injected CO₂ or other injected fluids to ensure that they effectively drive oil to a producing well. In addition to increasing production, tracking fluid boundaries can also identify where fluid is migrating in an undesirable direction and thus could be corrected to reduce waste. FIG. 1 shows highly simplified models of all three situations.

In one scenario, a well (denoted as 100 in FIG. 1) penetrates a layer that constitutes the reservoir. Well 100 may be drilled into the oil-bearing portion of the reservoir (denoted as 105), and the water-oil contact lies at some distance from well 100. In this case, knowing the oil-water boundary establishes the volume of oil. From a secondary recovery point of view, the oil-water boundary may be the result of water flooding from an adjacent well, pushing oil towards a recovery well (in this case, 105 in FIG. 1 refers to the water flooded region). Keeping in mind that this model is truly three dimensional (3D), it is extremely important to know the oil-water contact in plan view and to be able to monitor the contact to prevent water flood breakthrough. Alternatively, the well can be thought of as the source of water for a flooding operation, and now the goal is to map the horizontal and/or vertical water-oil contact to determine if the water is being channeled in a particular direction and/or is leaving large amounts of oil behind. Another scenario is simply that there is a large compartment of oil displaced from the well that has been bypassed or that is undiscovered (bypassed oil is denoted as 110 in FIG. 1). It would also be useful to be able to image the location and extent of other injected fluids such as CO₂, steam, chemicals and polymers (CO₂ is denoted as 115 in FIG. 1). These scenarios also highlight the importance of not only understanding where these boundaries exist but also being able to accurately target them while drilling and maximizing recovery through the precise placement of the wellbore with respect to the target. There is also great interest in mapping fractures induced to access oil contained in weakly permeable formations, including those associated with hydraulic-fracturing activities. Finally, it is very important to be able to monitor changes in reservoir properties over time whether by time-lapse snapshots and/or continuous monitoring.

Electromagnetic methods of geophysics are particularly well suited for mapping these situations because there is a high contrast in electrical resistance between the saline present in the formation, or injected during improved or enhanced oil recovery, and the oil-saturated reservoir. Because most reservoirs are confined to sedimentary formations that are relatively thin compared to their depth below the surface, it is difficult or impossible to map the boundaries in the above scenarios using surface-based electromagnetic techniques. It is known that the sensitivity to the targets (oil water contact, region of bypassed oil, region containing the injected fluid, etc.) in the above situations is increased dramatically if the measurements can be made in the vicinity of the target. These techniques make use of sources of electromagnetic fields and receivers (also referred to as sensors) that are either located within the well or in adjacent wells, with at least one in the well and at least one other on the surface or by using at least one Long conductor to inject current into the formation at depth.

Generally, when the depth of investigation is on the scale of kilometers, surface-based electromagnetic methods do not have the sensitivity to resolve resistivity contrasts at depth. This can be seen in FIG. 2, which shows the basic physics for a common surface electromagnetic method. The source 120 is an electric bipole consisting of two electrodes widely separated on a surface 121 where current is transmitted from one to the other (called the transmitter). The electric field Eₓ is measured along surface 121, approximated by the voltage drop ΔV between two potential sensors 122 a short distance L apart, usually called the receiver. Specifically, Eₓ=ΔV/L. For a uniform half space (i.e., where the electrical resistivity model contains only two values—one for the air above the ground surface and one for the earth below the ground surface), the electric field can be calculated analytically: when a body having a resistivity contrast with the half space is present, the current flow lines in the half space are distorted, and the surface fields change. The difference between the half space field and the field observed when the body is present is called the anomaly in E_{X}. In FIG. 2, the body is a simple sphere 125 that is less resistive than the surroundings. The half space current is drawn into the body, and for this shape the anomaly is the electric field of an induced electric dipole p. The field lines from the induced source oppose the primary field along the surface so the anomaly in Ex is negative. The strength of the induced dipole depends on the resistivity contrast, the strength of the primary field at the depth of the body and the depth of the body below the surface. In practical field surveys, the current electrodes are moved laterally, with varying spacing, and the electric fields are measured with an array of potential sensors on the surface for each source.

This simple model illustrates the problem with all surface-based transmitter-receiver arrays. The primary fields fall off very rapidly with depth, and the fields from the currents induced in a small object fall off very quickly back towards the surface. The primary field strength can of course be increased arbitrarily by increasing the source current. This is theoretically possible, but it is technically difficult because, in most geologic situations, it is extremely difficult (if not impossible) to emplace electrodes with low enough contact resistance to allow the injection of large enough currents. Keeping in mind that measurements should be made with sources at varying distances and azimuths from the well-head to define the horizontal outline of the target zone, the logistics of moving such large sources to many points on the surface becomes impractically expensive. These problems are not as great in shallow exploration because the sources can be smaller and easily deployable.

### Borehole to Surface Configurations

The situation is improved dramatically if the current source can be located in the vicinity of the feature of interest. The primary field in the vicinity of the body is now large, and even with the falloff of the induced fields towards the surface the measured anomalies are significantly larger. The installation of a dedicated source current electrode at the depth of interest for typical oil reservoir studies is not economically practical. However, many studies and practical field surveys have been conducted using the steel casing of a well as one of the electrodes in an electromagnetic survey. The idea seems to have been presented first by Rocroi and Kulikov (1985). They point out that the source produces higher current densities at depth than can be obtained from surface sources. In a field experiment, they used a point source at the surface and then the casing as a line source and differenced the results to obtain a residual anomaly that seemed to outline the boundaries of the known oilfield. The concept was picked up by Takacs and Hursan (1998) and by Newmark et al. (1999) for relatively shallow process monitoring.

With reference to FIGS. 3A and 3B, if a source of current is attached to a Long conductor 300, also referred to as a casing, at surface 305, the current flows down casing 300 and leaks radially off casing 300 into the medium. This phenomenon is illustrated schematically in FIGS. 3A and 3B. FIG. 3A shows surface electrodes. By contrast, in FIG. 3B the current source is connected to casing 300 at surface 305 and the leakage of current 310 into the formation is indicated by the horizontal arrows of decreasing magnitude emanating from casing 300.

Assuming perfect connection between the steel casing and the adjacent formation, Schenkel and Morrison (1990) and Kaufman (1990) derived a quantitative solution for the current leaving the casing, and the current along the casing, for a casing in a layered half space with layers of arbitrary resistivity. In general, the current leaks radially from the casing decreasing in a quasi-exponential manner with depth from the surface with variations caused by the layers. The casing can be represented as a succession of point pole current sources decreasing in amplitude from the surface downwards or by a succession of electric dipoles of magnitude Idl that fall off with depth. These studies show quantitatively that, for the same injected current, the primary field at the depth of the body of interest is larger when the casing is used to bring current down to the level of the body or target zone. With a larger primary field, the induced electric dipole moments are larger as are the anomalous fields at the surface. This solution can also be applied to the case of a current electrode placed at the bottom of the casing or, for that matter, a movable current electrode at various positions in the well. Three common current electrode configurations currently used in field studies are shown in FIGS. 4A-C.

In these examples, the return current can be located at some distance away or at the surface near the top of the well and is connected through the current generator 400 by a long wire to current electrodes at the surface 410 or at the bottom 420 of the casing. See FIGS. A and B respectively. Another configuration is illustrated in FIG. 4C for the movable electrode source 430 where the return current electrode is attached to the casing at the surface. These are examples of current electrode configurations; the examples of FIGS. 4B and 4C could be used in open-holes, i.e., where no or limited casing is present, and many other electrode configurations could be used. It should also be noted that these schematic diagrams are for electrode arrays that are collinear in a plane that passes through the well. For practical field surveys, the remote electrodes could be located along radial lines of various azimuths from the well, and the measuring sensors could similarly be located either along radial lines or on a rectangular grid on the surface or some mix of the two.

The above examples depict vertical wells with no deviation, but the same electrode configurations can be used with any wellbore trajectory, including vertical wells, deviated wells, or wells with a significant horizontal component.

It is current survey practice to derive a layered model of the subsurface using the resistivity logs from the well used for current injection and/or from other nearby wells. Alternatively, a more arbitrary resistivity model (i.e., not layered) can be derived from any modelling workflow. The currents leaking from the Long conductor can then be calculated using a formulation, such as the one developed by Schenkel and Morrison (1990) or any other numerical solution that models the electromagnetic, DC, Induced Polarization, or time domain response. These currents are then used as the source currents or source function. The return current electrode is usually at a point on or near the surface but may be modelled in other more numerically convenient ways. These currents can then be introduced in a 3D numerical model of the resistivity distribution in the earth. The model can comprise any 3D electrical resistivity distribution and is often derived from resistivity well logs constrained by seismic horizons. Interpretation usually involves an inversion procedure to find a distribution of resistivities in the region of the expected inhomogeneity that generates electric field anomalies that match those observed. The anomalies created for an arbitrary inhomogeneity near the well are critically dependent on the source function so the resulting interpretation also depends strongly on the source function.

The major problem in using a long conductor as an electrode in the way described above is that the current leakage is not only determined by the resistivity of the adjacent formation but also by the nature of the small-scale effects at the contact between the metal casing and the surrounding media. All the papers referenced above suggesting the use of the casing as a source highlight the problem of not accurately knowing the source function. Current leakage depends very much on the interface impedance between the metal of the casing and the ionic solution that carries the current in the formation. This is, at least in part, an electrochemical problem that depends on such things as the corrosion state of the interface and solution chemistry. The annulus between the casing and the drilled hole is customarily filled with cement. The quality or consistency of the cement job may have more influence on the radial current amplitude than the surrounding formation. The uncertainty in the source current distribution makes anything other than qualitative interpretation of the target zone very uncertain.

Including the examples discussed above, there is a body of prior art on the subject of using a casing source for geophysical exploration (Wilt, 1995; Morrison, World Patent Application Publication No. WO 2015/127211; Strack, U.S. Pat. No. 6,739,165), but in all of these cases the subject is not specific on how to account for uncertainty in the current flow along the casing. As mentioned above, many of these cases discuss the necessity of accurately knowing the current distribution, but none of them discuss methods to obtain this accurate knowledge. The present invention is different in that it provides methodologies for obtaining an accurate knowledge or estimate of the current flowing along the casing (and, by definition, this leads to accurate estimates of the leakage current).

A number of prior patents also describe methods for characterizing the casing, related fluids, and/or the cement (Stewart, U.S. Pat. No. 2,371,658; Stewart, U.S. Pat. No. 2,459,196; Davies, U.S. Pat. No. 4,794,322; Davies, U.S. Pat. No. 4,857,831). The goal of these works is to use measurements of the current flow along the casing to describe the condition and characteristics of the steel casing (e.g., is the casing corroded and, if so, by how much). The method of the present invention is not interested in understanding the condition of the casing, but in understanding how the current flows in the casing. This difference leads to practical design differences that differentiate how the measurements are made and how the measurements are used.

Similarly, there is a body of prior art dedicated to different methods for obtaining the formation resistivity from tools located inside a steel cased well (Vail, U.S. Pat. No. 6,246,240; Vail, U.S. Pat. No. 6,249,122; Vail, U.S. Pat. No. 6,577,144, Vail, U.S. Pat. No. 4,820,989; Vail, U.S. Pat. No. 4,882,542; Vail, U.S. Pat. No. 5,570,024; Vail, U.S. Pat. No. 5,633,590; Vail, U.S. Pat. No. 5,223,794; Vail, U.S. Pat. No. 6,025,721; Vail, U.S. Pat. No. 6,157,195; Vail, U.S. Pat. No. 6,157,195; Vail, U.S. Pat. No. 5,043,668; Kaufinan, U.S. Pat. No. 4,796,186; Sezginer, U.S. Pat. No. 5,510,712; Prammer, U.S. Pat. No. 6,765,387). These methods cause current to flow along the casing as well as into the geological formations outside of the steel casing. The overall goal of these works is to remove the effect of the casing to obtain measurements of the current flowing in the formations behind the steel casing. This differs from the method described herein in that the present invention is not trying to provide a method that is sensitive to the formation resistivity at all. The present invention is only interested in how the current flows in the casing. Similar to above, this difference in end goal leads to practical design differences that will be made more apparent below.

In addition, U.S. Application Publication No. 2017/0038492, which is incorporated herein by reference, describes the use of a borehole, and associated electrical conductors installed as part of a well completion, as a source antenna for geophysical applications. The conductors can comprise the well casing, tubing, rods and fluids, for example. This antenna is energized by deploying an electrode or other conductor, such as a metallic object, deep underground within the borehole with a wire or cable or attaching such a cable to the well casing at the surface or near the surface. The idea is to energize underground formations by applying a voltage from an external source at one or more positions within a borehole and place a return current electrode on the surface, near the surface, deep underground or in another borehole. The resulting electromagnetic field is measured on the surface, near the surface, or deep underground (such as in another borehole), and this field is used to determine the resistivity distribution within the earth.

### SUMMARY OF THE INVENTION

The present invention pertains to a system to infer or estimate the current flowing along a long conductor. A long conductor is a conductive body, such as metal (including but not limited to well casing, drill strings, tubing, or rods), fluids (including but not limited to water or brine) or a combination of metals and/or fluids, that creates an electrically conductive pathway from the surface or near the surface to the vicinity of target depth.

This capability has application in the field of borehole geophysics, which uses interpretation of measurements of ground currents to infer the composition of the subsurface, including formations containing desirable (or undesirable) geological properties, resources and/or fluids, such as oil, gas, water, steam, geothermal sources, carbon dioxide (CO₂), hydraulic-fracture fluids or proppants, ore bodies, hydrates, chemicals, polymers, karst, and pollutants.

The expanded use of long conductors, such as well casings, to distribute current into the subsurface works best with an accurate measurement of the current flowing along a long conductor and the current that is “leaking” into the formation. The present invention addresses this need.

While the terminology used herein often refers to oil, and oil specific applications, the present invention can be used in a wide range of applications. These applications include, but are not limited to, exploration, assessment, or characterization of: any hydrocarbon (such as gas), any combination of hydrocarbons (such as oil and gas), ore bodies or other mineral exploration targets, geothermal targets, any targets related to CO₂ injection (sequestration, storage, or enhanced oil recovery), wastewater disposal, groundwater, and underground fluid or gas storage.

For purposes of the present invention, the term “sensor” refers to any hardware specifically designed to sense either a single or a set of physical parameters and record the associated values for later interrogation. This includes any hardware associated with measuring potential differences, magnetic fields, or any other parameter that may be of interest. In general the present invention can be employed in an overall method of performing an electromagnetic geophysical survey of a subsurface volume of the earth.

The method of estimating a leakage current distribution along a long conductor extending into the earth includes transmitting current from a source to a long conductor extending into the earth. Current that leaks from the long conductor creates a leakage current distribution that extends from the long conductor. The method also includes taking a series of measurements (two or more) of the current at spaced sensing locations and determining the leakage current distribution along the long conductor from the series of measurements. At this point, it should be understood that the measurements of current need not be direct, i.e., the measurements need only be related to the current. For instance, the potential difference or other parameters could be measured from which current can be detennined. In any case, based on the leakage current distribution, the method of the invention can further include calculating a resistivity distribution within a subsurface volume with the leakage current distribution and determining a source current distribution from the leakage current distribution in connection with a geophysical survey. The leakage current distribution along the long conductor is preferably detennined by modeling, e.g. such as by forward and/or inverse modeling, of the series of measurements. The series of measurements is taken with the sensors located along the long conductor or along a ground surface proximate to the long conductor. A resistivity distribution within a subsurface volume is calculated using subsurface data, a background model and the leakage current distribution.

The present invention describes methods for inferring or estimating the flow of current within a long conductor and, by doing so, allows an estimation of the current leaking out of the long conductor. There are two broad categories of methods that are applicable to this: 1) making measurements using one or more sensors located inside the wellbore; and 2) making measurements using one or more sensors located in proximity to the wellhead along the ground surface or near the surface.

### Measurements Inside the Wellbore

The principle of this portion of the present invention is that a direct measurement of the electric field along the axis of the long conductor is a direct measurement of the electric field in or on the adjacent wall of the long conductor. The tangential electric field is continuous across the conductor wall-borehole solution interface, and the conductance of the conductor is so much higher than the conductance of even highly saline borehole fluid that the field along the axis of the conductor is not diminished by the borehole fluid. Consequently, the electric field along the axis of the long conductor E obtained by measuring the difference in potential ΔV between two sensors L meters apart is an approximate measure of the conductor's electric field. The dimensions of the long conductor are often known from the well design, and the resistivity of the metal is known from its specification, so the current in or on the long conductor is obtained through Ohm's law, I=ΔV/R_{C}, where R_{C} is the resistance of a length of conductor L given by R_{C}=ρ_{C}L/πd_{c}t_{c}, ρ_{C} is the resistivity of the conductor, d_{c} is the diameter of the conductor, and t_{c} is the thickness of the conductor. The current in this segment of length L is:

$${I}_{C} = \frac{Δ V}{\frac{{ρ}_{C} L}{π {d}_{C} {t}_{C}}} \qquad ( 1 )$$

The choice of L depends on the resolution desired for the source function electric dipole Idl or in this case IL. Generally, the source function is chosen to be some average in the vertical direction chosen such that the number of elementary dipoles is as small as possible in the sense that adding more would have negligible effect on the calculated values of the surface fields for the expected distribution of resistivities in the target region. For example, for a thick shale layer remote from the target area and made up of thin beds of alternating resistivity, the small-scale changes in E associated with each thin bed are typically of no or little interest, but the integrated current over the entire layer usually is of interest. In practice, the interval dl depends on the experiment design for a given geological situation.

### Measurements at the Surface

This portion of the present invention can be conducted either in conjunction with the above measurements or independently. In this part of the invention, the electric field and/or magnetic field is measured at one or more locations nearby the wellhead while current is transmitted into the long conductor following one of the methods described above, for example with regard to FIG. 4. An initial model of the casing is constructed using any available data (such as well logs, casing specifications, etc.). This initial model is used as input to a geophysical inversion algorithm and/or forward modelling scheme where the initial model is updated until an acceptable fit is found between the measured data and the calculated model response.

Additional objects, features and advantages of the invention will become more readily apparent from the following detailed description of preferred embodiments thereof when taken in conjunction with the drawings wherein like reference numerals refer to common parts in the several views.

### BRIEF DESCRIPTION OF THE DRAWINGS

FIG. 1 is a simplified view of a well and the surrounding subsurface;

FIG. 2 shows a common surface-based electromagnetic system;

FIG. 3A illustrates the current path for a source located at the surface;

FIG. 3B illustrates the current path for a source connected to a long conductor;

FIG. 4A shows a ground electrode configuration;

FIG. 4B shows a casing electrode configuration;

FIG. 4C shows a moveable in-casing electrode configuration;

FIG. 5A is a graph of an electric field along a casing length for two different subsurface models;

FIG. 5B is a graph of the electric field difference between the two models of FIG. 5A;

FIG. 6A is a graph of an electric field along a casing length for two different subsurface models;

FIG. 6B is a graph of the electric field difference between the two models of FIG. 6A;

FIG. 7A shows a system and measuring tool with downhole sensors in accordance with the present invention;

FIG. 7B shows a system and measuring tool with surface sensors in accordance with the present invention;

FIG. 8A is a schematic view of an electric field measuring tool of the present invention; and

FIG. 8B is a schematic view of the electric field measuring tool of FIG. 8A with a power supply and two current electrodes added.

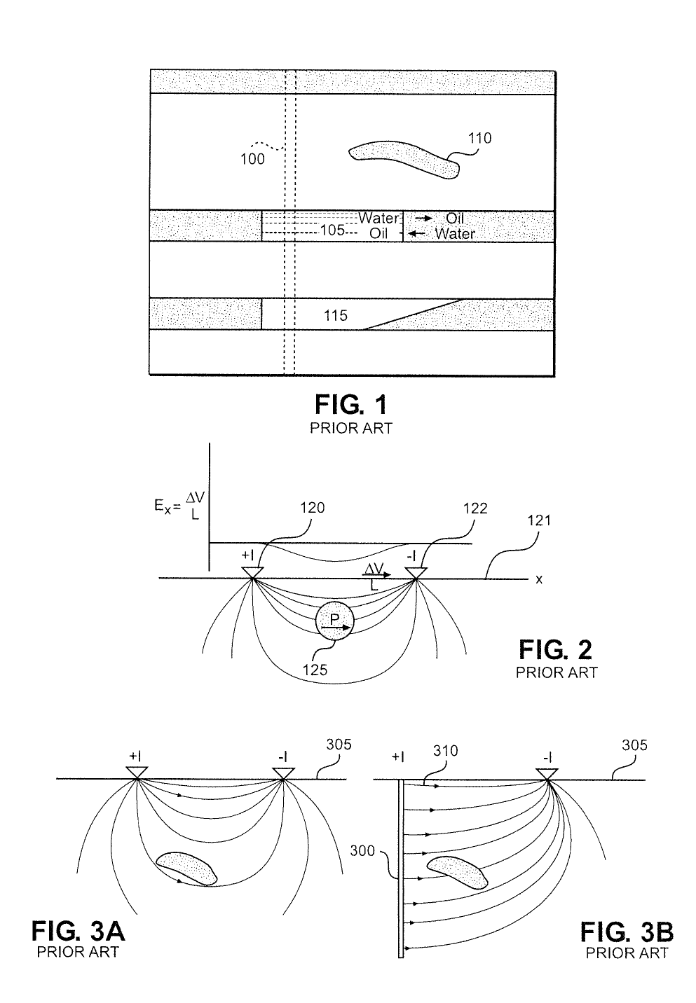

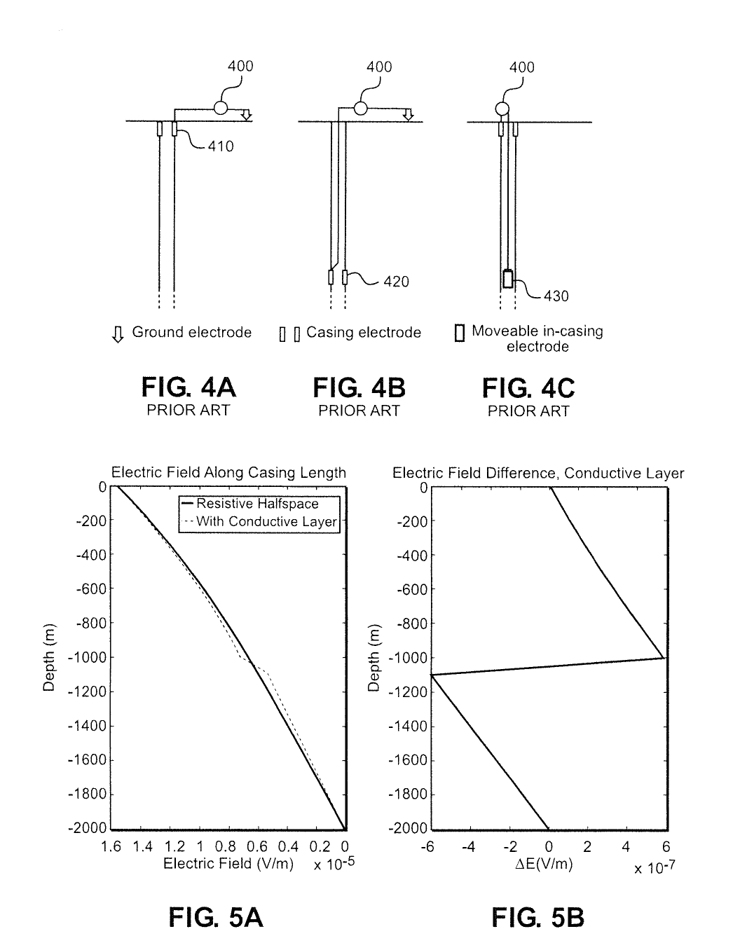

### DETAILED DESCRIPTION OF THE PREFERRED EMBODIMENTS

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art to employ the present invention.

### Measurements Inside the Wellbore

There have been attempts to measure the electric field along the axis of a well casing in a borehole but usually for measurement configurations in which the source is outside the casing, either on the surface or in an adjacent borehole. In this case, the casing acts as a shield, and the electric fields in the casing and in the borehole are very small. Compounding the problem, the measurements are usually made using metal-to-metal contact sensors on the inside of the casing, and the measurements have a high degree of contact voltage noise. Therefore, small fields together with a high degree of voltage noise make these kinds of measurements very difficult. In the case discussed here, the fields in the casing are much larger because the current is injected directly into the long conductor, and with a new generation of capacitively coupled sensors the contact noise can be almost eliminated.

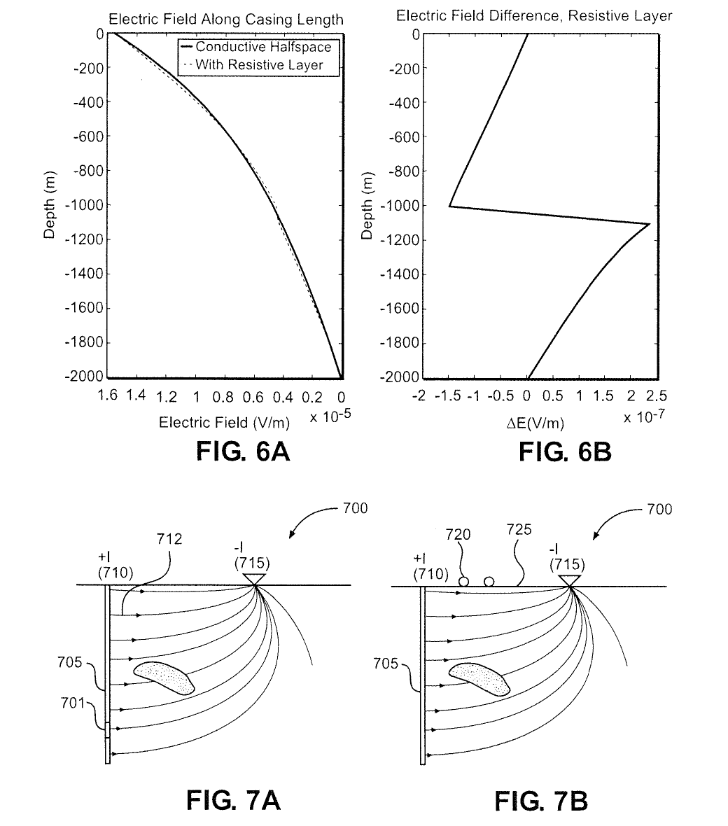

To illustrate the magnitude of the variations in the electric field in a casing passing through layers, FIGS. 5 and 6 show the calculated fields from two simple background models with a casing that is two kilometers long, passes through a layer that is 100 meters thick at a depth of one kilometer and has a current of one Ampere injected in the casing at the surface. In FIG. 5A, the dashed line shows the electric field calculated from a model where the layer is a relatively conductive ten Ohm meters, and the rest of the half space is a more resistive thirty Ohm meters. The solid line shows the fields from a uniform thirty Ohm meter half space. In FIG. 5B, the difference in electric fields between the two models is plotted on the expanded scale. FIGS. 6A and 6B show the same plots as in FIGS. 5A and 5B but for a model where the layer is more resistive (thirty Ohm meters), and the rest of the half space is more conductive (ten Ohm meters).

The field difference passing through the conductive layer (FIGS. 5A and 5B) is 12×10⁻⁷ V/m, and for the resistive layer (FIGS. 6A and 6B) it is 5.5×10⁻⁷ V/m. The layers basically look like an array of parallel resistors to the current leaving the casing. The resistive layer, being one high resistance value in the parallel resistor network, has relatively little impact on the current leaving the well. On the other hand, the conductive layer, being a low value in a parallel resistor network, channels a lot of current and modifies the voltage distribution down the well more than does the high value resistor. This indicates that differences in the electric field due to changes in the borehole are large enough to be measurable by a stable and accurate sensor.

The magnitudes of the electric field depicted in FIGS. 5A and 5B are easily measured with capacitive sensors and could potentially be measured with galvanic sensors or any other type of electric potential sensors. Capacitive sensors are fundamentally different from metal-to-metal contacting sensors or non-polarizing metal-metal electrolyte sensors used in the past. Being capacitively coupled to the conducting surroundings through an insulated (or mostly insulated) coating, they are independent (or mostly independent) of electrochemical contact effects or the solution chemistry. They consequently have very low intrinsic noise.

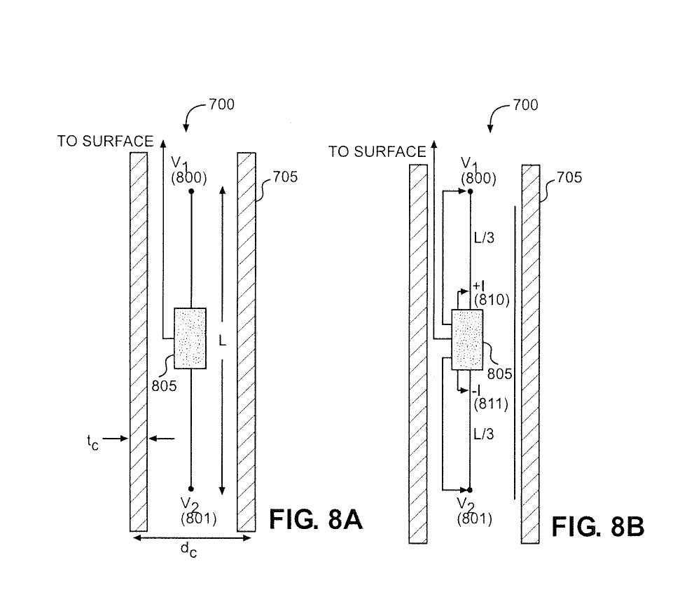

FIGS. 7A and 7B illustrate a system 700 for determining a leakage current distribution along at least a portion of a long conductor extending into the earth. Part of system 700, which includes a simple non-conductive structure supporting the spaced apart sensors with associated voltage amplifiers, power supply and an amplifier for sending the resulting voltage differences to the surface, is called an electric field measuring tool 701. Specifically, FIG. 7A shows an electric field measuring tool 701 in a long conductor 705. A source 710 is electrically or inductively connected to long conductor 705 and is configured to transmit current along long conductor 705 so that current leaks from along long conductor 705 forming a leakage current distribution 712 represented by a series of arrows with the length of each arrow representing the amount of current at that arrow. A receiver 715 measures an electromagnetic field generated by the current transmitted from source 710. In FIG. 7B sensors 720, are placed on or near the ground surface 725. A schematic rendering of tool 701 is shown in FIG. 8A. Tool 701 includes two sensors 800 and 801 and a control (or computer) system 805 configured to determine the leakage current distribution along the long conductor from a series of measurements. Computer system 805 is further configured to determine a source current distribution from leakage current distribution 712 in connection with a geophysical survey. For instance, computer system 805 can be configured to create a survey map from the source current distribution and a resistivity distribution within a subsurface volume with the leakage current distribution. Some of the sensors 720, 800, and 801 are magnetic field sensors or capacitive sensors. The sensor may be placed in, on or adjacent to long conductor 705 as shown in FIG. 7A or may be placed on or near the ground surface as shown in FIG. 7B. Sensors 720 are analogous to sensors 800 and 801 and are connected to a computer system (not shown) analogous to system 805, which works in the same manner. Source 710 is preferably a current source or a magnetic source and may be formed as a loop of wire. Natural sources may also be employed.

A demonstrated capacitive marine system had a sensor separation of one meter, and the noise level was observed to be approximately 1.0 nanovolt/√Hz at 1.0 Hz. This system is described in U.S. Patent Application Publication No. 2008/0246485, which is incorporated herein by reference. The corresponding noise level in V/m for a sensor spacing of 5.0 meters, which might be typical for the borehole tool, would be 0.2 nV/m/√Hz. From a practical point of view, such an electric field tool should accurately measure the change in electric field E passing through a layer. For example, from FIGS. 5 and 6, it would be desirable to accurately measure a change in field of 12×10⁻⁷ V/m across a conductive layer and 5.5×10⁻⁷ V/m across a resistive layer. The actual voltage difference for a 5.0-meter spacing would be five times that, and if 1.0 A of current were injected the electric field estimates are 6.0×10⁻⁶ V/m and 2.95×10⁻⁶ V/m, respectively. Given an expected noise level of 0.2 nV/m/√Hz, the signal-to-noise for these examples would be 3×10⁴ and approximately 1.5×10⁴, respectively. There may be unanticipated noise in the borehole so these signal-to-noise ratios could easily be increased by a factor of ten by using 10 Amperes of injected current. For this example, source function electric dipoles, Idl, are 5.0 meters long, and the current in each is calculated using the casing current expression shown above in Equation (1).

Usually, the dimensions and resistivity of the long conductor are accurately known and are constant along its length. However, there are situations where the conductor may have corroded, resulting in a change of wall thickness or even diameter, or the conductor may have been damaged. For these situations, the long conductor's resistance should be measured experimentally by the tool. This can be done by adding a power supply and two current electrodes to the tool, as shown schematically in FIG. 8B where the current electrodes are labeled 810 and 811. In this mode of operation, the tool is converted to a two electrode—two sensor system for measuring the long conductor's resistance. In this example, two current electrodes 810, 811 are introduced in the middle one third of the overall electrode length L. Following the nomenclature of FIG. 8B and noting the use of lowercase ν for voltage in the casing resistivity system, the voltage difference, Δν=ν²−ν₁, can be found via:

$${v}_{1} from \text{+} I current electrode , {v}_{1}^{+} = \frac{I {ρ}_{c} L / 3}{π {d}_{c} {t}_{c}}$$

$${v}_{1} from \text{-} I current electrode , {v}_{1}^{-} = \frac{- I {ρ}_{c} 2 L / 3}{π {d}_{c} {t}_{c}}$$

$${v}_{2} from \text{+} I current electrode , {v}_{2}^{+} = \frac{I {ρ}_{c} 2 L / 3}{π {d}_{c} {t}_{c}}$$

$${v}_{2} from \text{-} I current electrode , {v}_{2}^{-} = \frac{- I {ρ}_{c} L / 3}{π {d}_{c} {t}_{c}}$$

### Then:

$$Δ v = {v}_{2} - {v}_{1} = \frac{I {ρ}_{c} L / 3}{π {d}_{c} {t}_{c}} ( 2 - 1 + 1 + 2 ) = \frac{4}{3} I \frac{I {ρ}_{c} L}{π {d}_{c} {t}_{c}} \qquad ( 2 )$$

### From Equation (2):

$$\frac{{ρ}_{c} L}{π {d}_{c} {t}_{c}} = \frac{3}{4} \frac{Δ v}{I} \qquad ( 3 )$$

Substituting this equation in Equation (1) yields an expression for I_{C}:

$${I}_{C} = \frac{Δ V}{\frac{{ρ}_{C} L}{π {d}_{C} {t}_{C}}} = \frac{4}{3} I \frac{Δ V}{Δ v} \qquad ( 4 )$$

Equation (4) yields the required current flowing in or on the long conductor in terms of the measured change in voltage caused by the injected current and the measurements of voltage and current in the two electrode—two sensor mode of operation.

Equation (3) can be used to calculate the voltage ν expected for a given current via:

$$\frac{Δ v}{I} = \frac{{ρ}_{c} L}{π {d}_{c} {t}_{c}} \frac{4}{3}$$

Assuming a typical long conductor resistivity of 5.4×10⁶ Ohm meters, a diameter of 10 inches (0.254 m) and a wall thickness of 0.5 inch (0.0127 m),

$$\frac{Δ v}{I} = 1.2 \times {10}^{- 4} volts \text{/} ampere$$

Given the sensitivities noted above for the capacitive sensors, a current of only 10⁻³ A would provide more than enough voltage for the two electrode—two sensor measurement.

In practice, the measurements would typically be made sequentially—first, the voltage drop with the applied current in the long conductor and then, with that current turned off, the two electrode—two sensor resistivity mode is turned on. Both operations are controlled and voltage measurements made by control system 805 (shown in FIGS. 8A and 8B). All voltage and current values can be sent to the surface by way of the cable used to lower the tool in the well.

The most accurate measurements will be made with tool 701 stopped at regular intervals, for example, at separations of one tool length. More averaged estimates of casing current can be obtained by moving tool 701 continuously in the well, although it is anticipated that the tool will generate a certain amount of motion induced noise.

The tool and method described above are only one potential system for measuring the electrical current using sensors inside a long conductor. There exist alternative methods to measure potential differences inside a long conductor, such as connecting a source current to the conductor at the ground surface and lowering sensors down the conductor or attaching electric field sensors to a moveable electrode and measuring potential differences while transmitting current from the surface down the wire and into the long conductor at depth. In general, the present invention is directed to any method of placing sensors in a borehole with the intention of measuring a casing current for interpreting borehole-to-surface electromagnetic data.

The method described above also focuses on the measurement of the electric field along the axis of the long conductor, but alternatively the same method can be applied using sensors that are sensitive to the magnetic field inside a long conductor. Further to this, the source discussed above is an electrical current source. Alternatively, one could use a magnetic field source either at or near the surface or within the Long conductor itself. This includes the use of a loop of wire as a source or any other inductively coupled methods of causing current to flow in or on the long conductor, including natural fields.

### Measurements at the Surface

Measurements of the electric and/or magnetic field made at or near the surface while current is being passed into a nearby long conductor can be made such that they are sensitive to variations in the flow of current in or on the conductor. Measurements made very close to the wellhead (where the long conductor is near the ground surface) will be most sensitive to the current flowing in or on the conductor close to the surface, and further away the measurements become more sensitive to deeper current flow. Preferably the sensors extend in one or two directions along a one dimensional line to a distance approximately equal to the depth of the well or length of the conductor.

The data measured at multiple locations with varying radial distances from the wellhead can be used to determine if a particular model response matches or not, and in that way the surface data can be used to determine an accurate model of current flow on the casing.

There are a number of methods that can be used to derive an acceptable model of current flow from the data in this way. This can include the use of any form of calculating, modeling or other forms of determination used to derive the leakage current distribution from the sensed measurements. The term “modeling” includes, by way of examples, geophysical inversion methods, forward modelling procedures, or any form of modelling.

As in the previous method described, the source used here can be any method to cause currents to flow in or on the long conductor, including but not limited to an electrical current source, a magnetic field source, a loop of wire source, or any other inductively coupled methods that drives an electrical current in or on the long conductor.

Based on the above, it should be readily apparent that the present invention provides systems and methods for obtaining an accurate measurement or estimate of the flow of current along a long conductor and, by doing so, allows an estimation of the current leaking out of the long conductor. While certain preferred embodiments of the present invention have been set forth, it should be understood that various changes or modifications could be made without departing from the spirit of the present invention. In general, the invention is only intended to be limited by the scope of the following claims.

1. A method of estimating a leakage current distribution along at least a portion of a long conductor extending into the earth, said method comprising:
transmitting current from a source to a long conductor having a length and extending into the earth so that current leaks from the long conductor and creates a leakage current distribution from the long conductor;
taking a series of measurements related to the current with sensors wherein at least some of the sensors are: located at space locations on or in the long conductor; or extend away from the long conductor for a distance approximately equal to the length of the conductor; and
determining the leakage current distribution along the long conductor from the series of measurements.

2. The method of claim 1 further comprising calculating a resistivity distribution within a subsurface volume with the leakage current distribution.

3. The method of claim 2, further comprising determining a source current distribution from the leakage current distribution in connection with a geophysical survey.

4. The method of claim 3, further comprising creating a survey map from the source current distribution.

5. The method of claim 1, wherein determining the leakage current distribution along the long conductor includes modeling of the series of measurements.

6. The method of claim 5, wherein determining the leakage current distribution along the long conductor includes forward and/or inverse modeling of the series of measurements

7. The method of claim 1, wherein taking the series of measurements with the sensors includes taking measurements along the portion of the long conductor.

8. (canceled)

9. The method of claim 1, wherein taking the series of measurements with the sensors includes taking measurements along a ground surface proximate to the long conductor.

10. The method of claim 9, further comprising placing at least some of the sensors on or near the surface of the earth.

11. The method of claim 10, further comprising utilizing capacitive sensors as the sensors.

12. The method of claim 9, wherein at least some of the sensors are spaced in a line extending away from the long conductor.

13. (canceled)

14. The method of claim 1, wherein at least some of the sensors are placed adjacent to the long conductor.

15. A system for estimating a leakage current distribution along at least a portion of a long conductor extending into the earth, said system comprising:
a long conductor having a length and extending into the earth;
a source electrically or inductively connected to the long conductor and configured to transmit current along the long conductor so that current leaks from the long conductor and creates a leakage current distribution from the long conductor;
sensors located at spaced locations relative to the long conductor and configured to take a series of measurements related to the current, wherein at least some of the sensors are: located at space locations on or in the long conductor; or extend away from the long conductor for a distance approximately equal to the length of the conductor; and
a computer system configured to determine the leakage current distribution along the long conductor from the series of measurements.

16. The system of claim 15, wherein the computer system is further configured to determine a source current distribution from the leakage current distribution in connection with a geophysical survey.

17. The system of claim 15, wherein the computer system is further configured to calculate a resistivity distribution within a subsurface volume with the leakage current distribution.

18. (canceled)

19. The system of claim 15, wherein at least some of the sensors are adjacent to the long conductor.

20. The system of claim 15, wherein at least some of the sensors are provided along a ground surface proximate to the long conductor.

21. The system of claim 20, wherein the at least some of the sensors are spaced in a line extending away from the long conductor.

22. (canceled)

23. The system of claim 15, wherein at least some of the sensors are capacitive sensors.
